(19) United States
(12) Patent Application Publication
(10) Pub. No.: US 2022/0204243 A1
(43) Pub. Date: Jun. 30, 2022

(54) METHOD OF HANDLING OR MANIPULATING FLEXIBLE, DISSOLVABLE, POROUS ARTICLES

(71) Applicant: The Procter & Gamble Company, Cincinnati, OH (US)

(72) Inventors: CARL DAVID MAC NAMARA, BEIJING (CN); HONGSING TAN, BEIJING (CN)

(21) Appl. No.: 17/536,152

(22) Filed: Nov. 29, 2021

(30) Foreign Application Priority Data
Dec. 24, 2020 (CN) PCT/CN2020/138981

(51) Int. Cl. B65D 81/20; B65B 25/14; B65B 31/02

(52) U.S. Cl. CPC B65D 81/2007; B65B 31/02; B65B 25/14

(57) ABSTRACT

A method of handling or manipulating a flexible, dissolvable, porous article that is highly compressible and reboundable, can include applying a moderate force to said article to achieve a Volumetric Compression of 50% or more, followed by the step of removing said force to achieve a Volumetric Rebound of 80% or more in less than 10 minutes.

### FIELD OF THE INVENTION

The present invention relates a method of handling or manipulating flexible, dissolvable, porous articles.

### BACKGROUND OF THE INVENTION

Flexible and dissolvable sheets comprising surfactant(s) and/or other active ingredients in a water-soluble polymeric carrier or matrix have become well known in recent years. Such sheets are particularly useful for delivering surfactants and/or other active ingredients upon dissolution in water. In comparison with traditional granular or liquid forms in the same product category, such sheets have better structural integrity, are more concentrated and easier to store, ship/transport, carry, and handle. In comparison with the solid tablet form in the same product category, such sheets are more flexible and less brittle, with better sensory appeal to the consumers.

In order to deliver a sufficient amount of surfactant(s) and/or other active ingredients to achieve the desired benefit, such flexible and dissolvable sheets have been made thicker, or multiples of such sheets have been stacked together, to form a flexible and dissolvable article having a three-dimensional structure that can in turn be made into finished products of any shapes and/or colors, thereby granting great product design freedom for delighting the consumers.

However, such three-dimensional flexible and dissolvable article may suffer from significantly slower dissolution rate in water, in comparison with that of the thinner or single layer flexible and dissolvable sheet. Correspondingly, such flexible and dissolvable article is imparted with high porosity so as to improve its dissolution. On one hand, the high porosity effectively improves the dissolution rate of the resulting article; but on the other hand, it may greatly increase the total volume of such article, resulting in a finished product that is too bulky and takes up too much space, especially during shipping and storage.

### SUMMARY OF THE INVENTION

The present invention offers a solution to the above-mentioned problem, by providing a highly compressible and reboundable flexible, dissolvable, porous article, which can first be compressed to reduce its volume (thereby more suitable for shipping and storage) and subsequently decompressed to rebound back to its original volume and/or shape (thereby ready for use).

In one aspect, the present invention relates to a method of handling or manipulating a flexible, dissolvable, porous article comprising the steps of:
a) providing a flexible, dissolvable, porous article comprising a water-soluble polymer and a surfactant; wherein said flexible, dissolvable, porous article is characterized by: (1) a 50% Compression Force of less than 20,000 N/m²; and (2) a 90% Rebound Time of less than 5 minutes, when measured at 25° C. with an equilibrium humidity of 40%;
b) applying a force ranging from 500 N/m² to 100,000 N/m² to said flexible, dissolvable, porous article at a temperature ranging from 20° C. to 40° C. and an equilibrium humidity ranging from 20% to 95% so as to achieve a Volumetric Compression of 50% or more; and
c) removing the force from said compressed flexible, dissolvable, porous article so as to achieve a Volumetric Rebound of 80% or more in less than 10 minutes.

The force applied in Step (b) can be selected from the group consisting of pressure force, vacuum force, suction force, torque, and combinations thereof. Preferably, it is a pressure force or a vacuum force, or a combination thereof.

In another aspect, the present invention relates to a method of packaging a flexible, dissolvable, porous article comprising the steps of:
a) providing a flexible, dissolvable, porous article comprising a water-soluble polymer and a surfactant; wherein said flexible, dissolvable, porous article is characterized by a 50% Average Compression Force of less than 100,000 N/m² when measured at 25° C. with an equilibrium humidity of 40%;
b) placing one or more of said flexible, dissolvable, porous articles into a fluid-impermeable package;
c) applying a vacuum force to said flexible, dissolvable, porous articles to achieve a Volumetric Compression of 20% or more; and
d) sealing said fluid-impermeable package with the compressed flexible, dissolvable, porous articles inside.

In yet another aspect, the present invention relates to a compressed flexible, dissolvable, porous article comprising a water-soluble polymer and a surfactant, wherein said compressed article is characterized by a Volumetric Increase of 20% or more in less than 10 minutes upon decompression.

In still yet another aspect, the present invention relates to packaging for flexible, dissolvable, porous article comprising a water-soluble polymer and a surfactant, wherein said article is packed inside the packaging in a compressed state which reduced volume of the article by at least 10%, preferably at least 15%, more preferably 20% or more. This packaging in one aspect can be either flexible (e.g., laminated pouches or sachets), or rigid (e.g., thermoformed or molded containers).

These and other aspects of the present invention will become more apparent upon reading the following detailed description of the invention.

### DETAILED DESCRIPTION OF THE INVENTION

### I. Definitions

The term “flexible” as used herein refers to the ability of an article to withstand stress without breakage or significant fracture when it is bent at 90° along a center line perpendicular to its longitudinal direction. Preferably, such article can undergo significant elastic deformation and is characterized by a Young's Modulus of no more than 5 GPa, preferably no more than 1 GPa, more preferably no more than 0.5 GPa, most preferably no more than 0.2 GPa.

The term “dissolvable” as used herein refers to the ability of an article to completely or substantially dissolve in a sufficient amount of deionized water at 20° C. and under the atmospheric pressure within eight (8) hours without any stirring, leaving less than 5 wt % undissolved residues.

The term “solid” as used herein refers to the ability of an article to substantially retain its shape (i.e., without any visible change in its shape) at 20° C. and under the atmospheric pressure, when it is not confined and when no external force is applied thereto.

The term “sheet” as used herein refers to a non-fibrous structure having a three-dimensional shape, i.e., with a thickness, a length, and a width, while the length-to-thickness aspect ratio and the width-to-thickness aspect ratio are both at least about 5:1, and the length-to-width ratio is at least about 1:1. Preferably, the length-to-thickness aspect ratio and the width-to-thickness aspect ratio are both at least about 10:1, more preferably at least about 15:1, most preferably at least about 20:1; and the length-to-width aspect ratio is preferably at least about 1.2:1, more preferably at least about 1.5:1, most preferably at least about 1.618:1.

The term “open celled foam” or “open cell pore structure” as used herein refers to a solid, interconnected, polymer-containing matrix that defines a network of spaces or cells that contain a gas, typically a gas (such as air), without collapse of the foam structure during the drying process, thereby maintaining the physical strength and cohesiveness of the solid. The interconnectivity of the structure may be described by a Percent Open Cell Content (%), which is measured by Test 2 disclosed hereinafter.

The term “water-soluble” as used herein refers to the ability of a sample material to completely dissolve in or disperse into water leaving no visible solids or forming no visibly separate phase, when at least about 25 grams, preferably at least about 50 grams, more preferably at least about 100 grams, most preferably at least about 200 grams, of such material is placed in one liter (1L) of deionized water at 20° C. and under the atmospheric pressure with sufficient stirring.

The term “essentially free of” or “essentially free from” means that the indicated material is at the very minimal not deliberately added to the composition or product, or preferably not present at an analytically detectible level in such composition or product. It may include compositions or products in which the indicated material is present only as an impurity of one or more of the materials deliberately added to such compositions or products.

The term “Volumetric Compression” as used herein is defined as:

$$Volumetric Compression ( \% ) = \frac{( Vi - Vc )}{Vi} * 100 \% ,$$

wherein Vi is the volume of the flexible, dissolvable, porous article before application of force (i.e., before compression), and Vc is the volume of the flexible, dissolvable, porous article after application of force (i.e., after compression). Both volumes are measured at 25° C. with an equilibrium humidity of 40%.

The term “Volumetric Rebound” as used herein is defined as:

$$Volumetric Rebound ( \% ) = \frac{( Vr - Vc )}{Vc} * 100 \% ,$$

wherein Vc is the volume of the compressed flexible, dissolvable, porous article before removal of force (i.e., before decompression), and Vr is the volume of the flexible, dissolvable, porous article after removal of force for a certain duration (i.e., after decompression). Both volumes are measured at 25° C. with an equilibrium humidity of 40%.

### II. Handling/Manipulating the Flexible, Porous, Dissolvable Article

The present invention provides a method of handling or manipulating a flexible, dissolvable, porous article by compression and decompression, thereby improving the efficiency and reducing the cost of shipping and storage thereof.

The flexible, dissolvable, porous article is preferably highly compressible and reboundable. For example, it can be characterized by: (1) a 50% Compression Force of less than 20,000 N/m², preferably less than 12,000 N/m², more preferably less than 6,000 N/m², most preferably less than 3,000 N/m²; and (2) a 90% Rebound Time of less than 5 minutes, preferably less than 2 minutes, more preferably less than 1 minute, most preferably less than 30 seconds. Both the 50% Compression Force and the 90% Rebound Time are measured at 25° C. with an equilibrium humidity of 40%, according to the methods described hereinafter in Test 1.

The method of handling or manipulating the above-mentioned highly compressible and reboundable article may include a compression step, during which a moderate force ranging from 500 N/m² to 100,000 N/m² is applied to said flexible, dissolvable, porous article at a temperature ranging from 20° C. to 40° C. and an equilibrium humidity ranging from 20% to 95%, so as to achieve a Volumetric Compression of 50% or more. The force applied during the compression step can be selected from the group consisting of pressure force, vacuum force, suction force, torque, and combinations thereof. Preferably, the force is either pressure force or vacuum force, or a combination of both. The present invention achieves significant volumetric compression of the flexible, dissolvable, porous article by applying a relatively moderate force at relatively normal manufacturing/shipping/storage conditions (i.e., without the need for special processing conditions), which in turn enables efficient and low-cost shipping and storage thereof.

The method of handling or manipulating the above-mentioned highly compressible and reboundable article further includes a decompression step after the compression step, during which the previously applied force is removed from the compressed article so as to achieve a Volumetric Rebound of 80% or more in less than 10 minutes. Because the compressed article is capable of rebounding completely or nearly completely back to its original volume and/or shape within a relatively short duration upon decompression, its pore structures and the corresponding dissolution rate in water are not significantly affected by the compression and the decompression. More importantly, the aesthetic appeal of the flexible, dissolvable, porous article to the consumers is preserved despite the rigorous compression and decompression steps.

In a specific example of the present invention, a pressure force is applied by a human hand (e.g., that of a maker, a shipper, a consumer, and the like) to said flexible, dissolvable, porous article to achieve the Volumetric Compression of 50% or more under the above-mentioned conditions (i.e., at a temperature ranging from 20° C. to 40° C. and an equilibrium humidity ranging from 20% to 95%). In this specific example, the compression step can be easily achieved by a human hand, either in an attempt to test or demonstrate the high compressibility of the finished product, or to prepare said product for shipping or storage.

In another specific example of the present invention, a pressure force is applied by a compressing plate on a packing line to said flexible, dissolvable, porous article to achieve the Volumetric Compression of 50% or more under the above-mentioned conditions (i.e., at a temperature ranging from 20° C. to 40° C. and an equilibrium humidity ranging from 20% to 95%). One or more of the compressed articles can then be placed into a fluid-impermeable package in preparation for shipping and storage as a finished product. Said fluid-impermeable package continues to apply an equivalent pressure force within the above-specified range onto the compressed article(s) during shipping and storage. Once the finished product arrives in the hands of a consumer, the fluid-impermeable package is opened, and the applied pressure force is removed. Immediately, the compressed article starts to rebound and is able to regain its original volume and/or shape completely or nearly within a relatively short time frame.

In yet another example of the present invention, one or more of said flexible, dissolvable, porous articles are first placed inside a fluid-impermeable package, and then a vacuum force is applied to said article(s) by a vacuum-suction device on a packing line to achieve the Volumetric Compression of 50% or more under the above-mentioned conditions (i.e., at a temperature ranging from 20° C. to 40° C. and an equilibrium humidity ranging from 20% to 95%). Once the above-mentioned compression is achieved, the fluid-impermeable package is sealed to form a finished product that is ready for shipping and storage as a finished product. The sealed fluid-impermeable package continues to apply an equivalent vacuum force within the above-specified range onto the compressed article(s) during shipping and storage. Once the finished product arrives in the hands of a consumer, the sealed fluid-impermeable package is opened, e.g., by said consumer breaking the seal of the package, and the applied vacuum force is removed. Immediately, the compressed article starts to rebound and is able to regain its original volume and/or shape completely or nearly within a relatively short time frame.

The present invention also covers a method of vacuum-packing a flexible, dissolvable, porous article that is necessarily as compressible and reboundable as that described hereinabove. In order to enable vacuum-packing, it is sufficient that the flexible, dissolvable, porous article has a 50% Compression Force of less than 100,000 N/m², preferably less than 25,000 N/m², more preferably less than 20,000 N/m², most preferably less than 15,000 N/m² when measured at 25° C. with an equilibrium humidity of 40%. Such a flexible, dissolvable, porous article can be readily vacuum-packed to achieve moderate volumetric compression that still enables significant improvement of the shipping and storage efficiency and reduction of the associated costs. Specifically, one or more of said flexible, dissolvable, porous articles are placing into a fluid-impermeable package, and a vacuum force is then applied to said flexible, dissolvable, porous articles to achieve a Volumetric Compression of 20% or more, preferably 30% or more, more preferably 40% or more, most preferably 50% or more. The vacuum-packing process as mentioned hereinabove can be readily achieved by any vacuum-packing equipment known in the art.

Once the desired Volumetric Compression is achieved, the fluid-impermeable package is sealed with the compressed flexible, dissolvable, porous articles inside, which is then shipped and stored as a finished product. Subsequently upon decompression (e.g., as effectuated by opening of the sealed fluid-impermeable package), the compressed article is capable of rebounding completely or nearly back to its original volume and/or shape. Preferably, the compressed article is characterized by a Volumetric Rebound of 20% or more, preferably 40% or more, more preferably 60% or more, most preferably 80% or more, in less than 10 minutes upon decompression.

### III. Physical Structures and Characteristics of the Flexible, Dissolvable, Porous Article

The flexible, dissolvable, porous article of the present invention is preferably characterized by an open-celled foam (OCF) structures that allow easier water ingress into the sheet and faster dissolution of the sheet in water. For example, such article may be characterized by: (i) a Percent Open Cell Content of from about 80% to 99%, preferably from about 85% to 99%, more preferably from about 90% to 99%, as measured by the Test 2 hereinafter; and (ii) an Overall Average Pore Size of from about 100 μm to about 2000 μm, preferably from about 150 μm to about 1000 μm, more preferably from about 200 μm to about 600 μm, as measured by the Micro-CT method described in Test 3 hereinafter. The Overall Average Pore Size defines the porosity of the OCF structure of the present invention. The Percent Open Cell Content defines the interconnectivity between pores in the OCF structure of the present invention. Interconnectivity of the OCF structure may also be described by a Star Volume or a Structure Model Index (SMI) as disclosed in WO2010077627 and WO2012138820.

Preferably, the flexible, dissolvable, porous article of the present invention is further characterized by an Average Cell Wall Thickness of from about 5 μm to about 200 μm, preferably from about 10 μm to about 100 μm, more preferably from about 10 μm to about 80 μm, as measured by Test 3 hereinafter.

The article of the present invention can be of any suitable shape, either regular or irregular, e.g., spherical, cubic, rectangular, polygonal, oblong, cylindrical, rod, sheet, flower-shaped, fan-shaped, star-shaped, disc-shaped, and the like. It may be characterized by a maximum dimension D and a minimum dimension z (which is perpendicular to the maximum dimension D), while the ratio of D/z (hereinafter also referred to as the “Aspect Ratio”) may range from 1 to about 10, preferably from about 1.4 to about 9, preferably from about 1.5 to about 8, more preferably from about 2 to about 7. When the Aspect Ratio is 1, the article has a spherical shape. When the Aspect Ratio is about 1.4, the article has a cubical shape. The article of the present invention may have a minimal dimension z that is greater than about 3 mm but less than about 20 cm, preferably from about 4 mm to about 10 cm, more preferably from about 5 mm to about 30 mm.

The flexible, dissolvable, porous article of the present invention may have a single layer structure made from a thick flexible, dissolvable, porous sheet. Alternatively, it may have a multilayer structure comprising a plurality of flexible, dissolvable, porous sheets stacked together, preferably in a self-adhering manner without any added adhesives. Each of said flexible, dissolvable, porous sheets may have a thickness ranging from about 0.5 mm to about 4 mm, preferably from about 0.6 mm to about 3.5 mm, more preferably from about 0.7 mm to about 3 mm, still more preferably from about 0.8 mm to about 2 mm, most preferably from about 1 mm to about 1.5 mm, as measured by Test 4 hereinafter. Said multilayer structure may comprise any number of the above-mentioned sheets, e.g., from about 4 to about 50, preferably from about 5 to about 40, more preferably from about 6 to about 30. In a particularly preferred embodiment of the present invention, the multilayer structure comprises from 15 to 40 layers of the above-described flexible, dissolvable, porous sheets and has an aspect ratio ranging from about 2 to about 7.

The flexible, dissolvable, porous article of the present invention may contain a small amount of water. Preferably, it is characterized by a final moisture content of from 0.5% to 25%, preferably from 1% to 20%, more preferably from 3% to 10%, by weight of the solid sheet, as measured by Test 5 hereinafter. An appropriate final moisture content in the resulting solid sheet may ensure the desired flexibility/deformability of the sheet, as well as providing soft/smooth sensory feel to the consumers. If the final moisture content is too low, the sheet may be too brittle or rigid. If the final moisture content is too high, the sheet may be too sticky, and its overall structural integrity may be compromised.

The flexible, dissolvable, porous article of the present invention may further be characterized by a basis weight of from about 50 grams/m² to about 500 grams/m², preferably from about 150 grams/m² to about 450 grams/m², more preferably from about 250 grams/m² to about 400 grams/m², as measured by Test 6 described hereinafter.

Still further, the flexible, dissolvable, porous article of the present invention may have a density ranging from about 0.05 grams/cm³ to about 0.5 grams/cm³, preferably from about 0.06 grams/cm³ to about 0.4 grams/cm³, more preferably from about 0.07 grams/cm³ to about 0.2 grams/cm³, most preferably from about 0.08 grams/cm³ to about 0.15 grams/cm³, as measured by Test 7 hereinafter. The density of the article of the present invention may be indicative of its porosity and may impact its dissolution rate, e.g., the lower the density, the more porous the article and the faster its dissolution rate.

Furthermore, the flexible, dissolvable, porous article of the present invention can be characterized by a Specific Surface Area of from about 0.03 m²/g to about 0.25 m²/g, preferably from about 0.04 m²/g to about 0.22 m²/g, more preferably from 0.05 m²/g to 0.2 m²/g, most preferably from 0.1 m²/g to 0.18 m²/g, as measured by Test 8 described hereinafter. The Specific Surface Area of the article of the present invention may also be indicative of its porosity and may impact its dissolution rate, e.g., the greater the Specific Surface Area, the more porous the article and the faster its dissolution rate.

In a preferred embodiment, the flexible, dissolvable, porous article according to the present disclosure and/or the dissolvable solid article according to the present disclosure is characterized by:
a Percent Open Cell Content of from 85% to 99%, preferably from 90% to 99%; and/or
an Overall Average Pore Size of from 150 μm to 1000 μm, preferably from 200 μm to 600 μm; and/or
an Average Cell Wall Thickness of from 5 μm to 200 μm, preferably from 10 μm to 100 μm, more preferably from 10 μm to 80 μm; and/or
a Final Moisture Content of from 0.5% to 25%, preferably from 1% to 20%, more preferably from 3% to 10%, by weight of the article; and/or
a basis weight of from about 50 grams/m² to about 500 grams/m², preferably from about 150 grams/m² to about 450 grams/m², more preferably from about 250 grams/m² to about 400 grams/m²; and/or
a density of from 0.05 grams/cm³ to 0.5 grams/cm³, preferably from 0.06 grams/cm³ to 0.4 grams/cm³, more preferably from 0.07 grams/cm³ to 0.2 grams/cm³, most preferably from 0.08 grams/cm³ to 0.15 grams/cm³; and/or
a Specific Surface Area of from 0.03 m²/g to 0.25 m²/g, preferably from 0.04 m²/g to 0.22 m²/g, more preferably from 0.05 m²/g to 0.2 m²/g, most preferably from 0.1 m²/g to 0.18 m²/g.

### III. Formulations of the Flelexible, Porous, Dissolvable Article

The flexible, porous, dissolvable article of the present invention comprises at least a water-soluble polymer and a surfactant.

The water-soluble polymer in the flexible, porous, dissolvable article may function as a film-former, a structurant as well as a carrier for other active ingredients (e.g., surfactants, emulsifiers, builders, chelants, perfumes, colorants, and the like).

The water-soluble polymer can be present in the flexible, porous, dissolvable article of the present invention in an amount ranging from about 5% to about 50%, preferably from about 8% to about 40%, more preferably from about 10% to about 30%, most preferably from about 11% to about 25%, by total weight of the article. In a particularly preferred embodiment of the present invention, the total amount of water-soluble polymer(s) present in the flexible, porous, dissolvable article of the present invention is no more than about 25% by total weight of such article.

Water-soluble polymers suitable for the practice of the present invention may be selected those with weight average molecular weights ranging from about 50,000 to about 400,000 Daltons, preferably from about 60,000 to about 300,000 Daltons, more preferably from about 70,000 to about 200,000 Daltons, most preferably from about 80,000 to about 150,000 Daltons. The weight average molecular weight is computed by summing the average molecular weights of each polymer raw material multiplied by their respective relative weight percentages by weight of the total weight of polymers present within the porous solid. The weight average molecular weight of the water-soluble polymer used herein may impact the viscosity of the wet pre-mixture, which may in turn influence the bubble number and size during the aeration step as well as the pore expansion/opening results during the drying step. Further, the weight average molecular weight of the water-soluble polymer may affect the overall film-forming properties of the wet pre-mixture and its compatibility/incompatibility with certain surfactants.

The water-soluble polymers of the present invention may be selected from synthetica polymers, naturally sourced polymers, or modified natural polymers.

Suitable synthetic polymers include polyvinyl alcohols, polyvinylpyrrolidones, polyalkylene oxides, polyacrylates, caprolactams, polymethacrylates, polymethylmethacrylates, polyacrylamides, polymethylacrylamides, polydimethylacrylamides, polyethylene glycol monomethacrylates, copolymers of acrylic acid and methyl acrylate, polyurethanes, polycarboxylic acids, polyvinyl acetates, polyesters, polyamides, polyamines, polyethyleneimines, maleic/(acrylate or methacrylate) copolymers, copolymers of methylvinyl ether and of maleic anhydride, copolymers of vinyl acetate and crotonic acid, copolymers of vinylpyrrolidone and of vinyl acetate, copolymers of vinylpyrrolidone and of caprolactam, vinyl pyrollidone/vinyl acetate copolymers, copolymers of anionic, cationic and amphoteric monomers, and combinations thereof.

Preferred water-soluble polymers of the present invention include polyvinyl alcohols, polyvinylpyrrolidones, polyalkylene oxides, starch and starch derivatives, pullulan, gelatin, hydroxypropylmethylcelluloses, methycelluloses, and carboxymethycelluloses. More preferred water-soluble polymers of the present invention include polyvinyl alcohols, especially those characterized by a degree of hydrolysis ranging from about 40% to about 100%, preferably from about 50% to about 95%, more preferably from about 65% to about 92%, most preferably from about 70% to about 90%. Commercially available polyvinyl alcohols include those from Celanese Corporation (Texas, USA) under the CELVOL trade name including, but not limited to, CELVOL 523, CELVOL 530, CELVOL 540, CELVOL 518, CELVOL 513, CELVOL 508, CELVOL 504; those from Kuraray Europe GmbH (Frankfurt, Germany) under the Mowiol® and POVAL™ trade names; and PVA 1788 (also referred to as PVA BP17) commercially available from various suppliers including Lubon Vinylon Co. (Nanjing, China); and combinations thereof. In a particularly preferred embodiment of the present invention, the flexible, porous, dissolvable article comprises from about 10% to about 25%, more preferably from about 15% to about 23%, by total weight of such article, of a polyvinyl alcohol having a weight average molecular weight ranging from 80,000 to about 150,000 Daltons and a degree of hydrolysis ranging from about 80% to about 90%.

In addition to the water-soluble polymer described hereinabove, the flexible, porous, dissolvable article of the present invention comprises one or more surfactants.

The surfactants may function as emulsifying agents during the aeration process (as described hereinafter) to create a sufficient amount of stable bubbles for forming the desired OCF structure of the present invention. Examples of emulsifiers for use as a surfactant component herein include mono- and di-glycerides, fatty alcohols, polyglycerol esters, propylene glycol esters, sorbitan esters and other emulsifiers known or otherwise commonly used to stabilize air interfaces.

Further, the surfactants may function as active ingredients for delivering a desired cleansing benefit. Suitable surfactants for such purpose can be selected from the group consisting of anionic surfactants, nonionic surfactants, cationic surfactants, zwitterionic surfactants, amphoteric surfactants, polymeric surfactants or combinations thereof.

The total amount of surfactants in the flexible, porous, dissolvable article of the present invention preferably range from about 30% to about 90%, preferably from about 40% to about 80%, more preferably from about 50% to about 70%, by total weight of said article.

Non-limiting examples of anionic surfactants suitable for use herein include alkyl and alkyl ether sulfates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, sodium lauroyl glutamate, and combinations thereof.

One category of anionic surfactants particularly suitable for practice of the present invention include C6-C20 linear or branched alkylalkoxy sulfates (AAS). Among this category, linear or branched alkylethoxy sulfates (AES) having the respective formulae RO(C₂H₄O)ₓSO₃M are particularly preferred, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms. The AES surfactants are typically made as condensation products of ethylene oxide and monohydric alcohol's having from about 6 to about 20 carbon atoms. Useful alcohols can be derived from fats, e.g., coconut oil or tallow, or can be synthetic. Lauryl alcohol and straight chain alcohol's derived from coconut oil are preferred herein. Such alcohol's are reacted with about 0.1 to about 10, preferably from about 0.5 to about 5, and especially about 1-3, molar proportions of ethylene oxide and the resulting mixture of molecular species having, for example, an average of 1-3 moles of ethylene oxide per mole of alcohol, is sulfated and neutralized. Highly preferred AES are those comprising a mixture of individual compounds, said mixture having an average alkyl chain length of from about 10 to about 16 carbon atoms and an average degree of ethoxylation of from about 1 to about 4 moles of ethylene oxide.

Another category of anionic surfactants suitable for practice of the present invention include C₆-C₂₀ linear alkylbenzene sulphonate (LAS) surfactant. Exemplary C₁₀-C₂₀ linear alkylbenzene sulfonates that can be used in the present invention include alkali metal, alkaline earth metal or ammonium salts of C₁₀-C₂₀ linear alkylbenzene sulfonic acids, and preferably the sodium, potassium, magnesium and/or ammonium salts of C₁₁-C₁₈ or C₁₁-C₁₄ linear alkylbenzene sulfonic acids. More preferred are the sodium or potassium salts of C₁₂ and/or C₁₄ linear alkylbenzene sulfonic acids, and most preferred is the sodium salt of C₁₂ and/or C₁₄ linear alkylbenzene sulfonic acid, i.e., sodium dodecylbenzene sulfonate or sodium tetradecylbenzene sulfonate.

Another category of anionic surfactants suitable for practice of the present invention include sodium trideceth sulfates (STS) having a weight average degree of alkoxylation ranging from about 0.5 to about 5, preferably from about 0.8 to about 4, more preferably from about 1 to about 3, most preferably from about 1.5 to about 2.5. Trideceth is a 13-carbon branched alkoxylated hydrocarbon comprising, in one embodiment, an average of at least 1 methyl branch per molecule. STS used by the present invention may be include ST(EOxPOy)S, while EOx refers to repeating ethylene oxide units with a repeating number x ranging from 0 to 5, preferably from 1 to 4, more preferably from 1 to 3, and while POy refers to repeating propylene oxide units with a repeating number y ranging from 0 to 5, preferably from 0 to 4, more preferably from 0 to 2. It is understood that a material such as ST2S with a weight average degree of ethoxylation of about 2, for example, may comprise a significant amount of molecules which have no ethoxylate, 1 mole ethoxylate, 3 mole ethoxylate, and so on, while the distribution of ethoxylation can be broad, narrow or truncated, which still results in an overall weight average degree of ethoxylation of about 2. STS is particularly suitable for personal cleansing applications.

Another category of anionic surfactants suitable for practice of the present invention include alkyl sulfates. These materials have the respective formulae ROSO₃M, wherein R is alkyl or alkenyl of from about 6 to about 20 carbon atoms, x is 1 to 10, and M is a water-soluble cation such as ammonium, sodium, potassium and triethanolamine. Preferably, R has from about 6 to about 18, preferably from about 8 to about 16, more preferably from about 10 to about 14, carbon atoms.

Other suitable anionic surfactants include water-soluble salts of the organic, sulfuric acid reaction products of the general formula [R¹—SO₃—M], wherein R¹ is chosen from the group consisting of a straight or branched chain, saturated aliphatic hydrocarbon radical having from about 6 to about 20, preferably about 10 to about 18, carbon atoms; and M is a cation. Preferred are alkali metal and ammonium sulfonated C₁₀₋₁₈ n-paraffins. Other suitable anionic surfactants include olefin sulfonates having about 12 to about 24 carbon atoms. The α-olefins from which the olefin sulfonates are derived are mono-olefins having about 12 to about 24 carbon atoms, preferably about 14 to about 16 carbon atoms. Preferably, they are straight chain olefins.

Other suitable anionic surfactants includes β-alkyloxy alkane sulfonates; the reaction products of fatty acids esterified with isethionic acid and neutralized with sodium hydroxide; sodium or potassium salts of fatty acid amides of methyl tauride; succinamates; ester derivatives of sodium sulfosuccinic acid.

Nonionic surfactants that can be included into the article of the present invention may be any conventional nonionic surfactants, including but not limited to: alkyl alkoxylated alcohols, alkyl alkoxylated phenols, alkyl polysaccharides (especially alkyl glucosides and alkyl polyglucosides), polyhydroxy fatty acid amides, alkoxylated fatty acid esters, sucrose esters, sorbitan esters and alkoxylated derivatives of sorbitan esters, amine oxides, and the like. Preferred nonionic surfactants are those of the formula R¹(OC₂H₄)ₙOH, wherein R¹ is a C₈-C₁₈ alkyl group or alkyl phenyl group, and n is from about 1 to about 80. Particularly preferred are C₈-C₁₈ alkyl ethoxylated alcohols having a weight average degree of ethoxylation from about 1 to about 20, preferably from about 5 to about 15, more preferably from about 7 to about 10, such as NEODOL® nonionic surfactants commercially available from Shell. Other non-limiting examples of nonionic surfactants useful herein include: C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched alkyl alkoxylates, BAEₓ, wherein x is from 1 to 30; alkyl polysaccharides, specifically alkyl polyglycosides; Polyhydroxy fatty acid amides; and ether capped poly(oxyalkylated) alcohol surfactants. Suitable nonionic surfactants also include those sold under the tradename Lutensol® from BASF.

In a preferred embodiment, the nonionic surfactant is selected from sorbitan esters and alkoxylated derivatives of sorbitan esters including sorbitan monolaurate (SPAN® 20), sorbitan monopalmitate (SPAN® 40), sorbitan monostearate (SPAN® 60), sorbitan tristearate (SPAN® 65), sorbitan monooleate (SPAN® 80), sorbitan trioleate (SPAN® 85), sorbitan isostearate, polyoxyethylene (20) sorbitan monolaurate (Tween® 20), polyoxyethylene (20) sorbitan monopalmitate (Tween® 40), polyoxyethylene (20) sorbitan monostearate (Tween® 60), polyoxyethylene (20) sorbitan monooleate (Tween® 80), polyoxyethylene (4) sorbitan monolaurate (Tween® 21), polyoxyethylene (4) sorbitan monostearate (Tween® 61), polyoxyethylene (5) sorbitan monooleate (Tween® 81), all available from Uniqema, and combinations thereof.

The most preferred nonionic surfactants for practice of the present invention include C₆-C₂₀ linear or branched alkylalkoxylated alcohols (AA) having a weight average degree of alkoxylation ranging from 5 to 15, more preferably C₁₂-C₁₄ linear ethoxylated alcohols having a weight average degree of alkoxylation ranging from 7 to 9.

Amphoteric surfactants suitable for use in the article of the present invention includes those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isethionate, and N-higher alkyl aspartic acids. One category of amphoteric surfactants particularly suitable for incorporation into articles for personal care applications (e.g., shampoo, facial or body cleanser, and the like) include alkylamphoacetates, such as lauroamphoacetate and cocoamphoacetate. Alkylamphoacetates can be comprised of monoacetates and diacetates. In some types of alkylamphoacetates, diacetates are impurities or unintended reaction products. If present, the amount of alkylamphoacetate(s) in the solid sheet of the present invention may range from about 2% to about 40%, preferably from about 5% to about 30%, more preferably from about 10% to about 20%, by total weight of the article.

Zwitterionic surfactants suitable include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate.

Other zwitterionic surfactants suitable for use herein include betaines, including high alkyl betaines such as coco dimethyl carboxymethyl betaine, cocoamidopropyl betaine, cocobetaine, lauryl amidopropyl betaine, oleyl betaine, lauryl dimethyl carboxymethyl betaine, lauryl dimethyl alphacarboxyethyl betaine, cetyl dimethyl carboxymethyl betaine, lauryl bis-(2-hydroxyethyl) carboxymethyl betaine, stearyl bis-(2-hydroxypropyl) carboxymethyl betaine, oleyl dimethyl gamma-carboxypropyl betaine, and lauryl bis-(2-hydroxypropyl)alpha-carboxyethyl betaine. The sulfobetaines may be represented by coco dimethyl sulfopropyl betaine, stearyl dimethyl sulfopropyl betaine, lauryl dimethyl sulfoethyl betaine, lauryl bis-(2-hydroxyethyl) sulfopropyl betaine and the like; amidobetaines and amidosulfobetaines, wherein the RCONH(CH₂)₃ radical, wherein R is a C₁₁-C₁₇ alkyl, is attached to the nitrogen atom of the betaine are also useful in this invention.

Cationic surfactants can also be utilized in the present invention, especially in fabric softener and hair conditioner products. When used in making products that contain cationic surfactants as the major surfactants, it is preferred that such cationic surfactants are present in an amount ranging from about 2% to about 30%, preferably from about 3% to about 20%, more preferably from about 5% to about 15% by total weight of the solid sheet.

Cationic surfactants may include DEQA compounds, which encompass a description of diamido actives as well as actives with mixed amido and ester linkages. Preferred DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids.

Suitable polymeric surfactants for use in the personal care compositions of the present invention include, but are not limited to, block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquaternary polydimethylsiloxanes, and co-modified amino/polyether silicones.

In a preferred embodiment of the present invention, the flexible, porous, dissolvable article of the present invention further comprises a plasticizer, preferably in the amount ranging from about 0.1% to about 25%, preferably from about 0.5% to about 20%, more preferably from about 1% to about 15%, most preferably from 2% to 12%, by total weight of said article.

Suitable plasticizers for use in the present invention include, for example, polyols, copolyols, polycarboxylic acids, polyesters, dimethicone copolyols, and the like.

Examples of useful polyols include, but are not limited to: glycerin, diglycerin, ethylene glycol, polyethylene glycol (especially 200-600), propylene glycol, butylene glycol, pentylene glycol, glycerol derivatives (such as propoxylated glycerol), glycidol, cyclohexane dimethanol, hexanediol, 2,2,4-trimethylpentane-1,3-diol, pentaerythritol, urea, sugar alcohols (such as sorbitol, mannitol, lactitol, xylitol, maltitol, and other mono- and polyhydric alcohols), mono-, di- and oligo-saccharides (such as fructose, glucose, sucrose, maltose, lactose, high fructose corn syrup solids, and dextrins), ascorbic acid, sorbates, ethylene bisformamide, amino acids, and the like.

Examples of polycarboxylic acids include, but are not limited to citric acid, maleic acid, succinic acid, polyacrylic acid, and polymaleic acid.

Examples of suitable polyesters include, but are not limited to, glycerol triacetate, acetylated-monoglyceride, diethyl phthalate, triethyl citrate, tributyl citrate, acetyl triethyl citrate, acetyl tributyl citrate.

Examples of suitable dimethicone copolyols include, but are not limited to, PEG-12 dimethicone, PEG/PPG-18/18 dimethicone, and PPG-12 dimethicone.

Other suitable platicizers include, but are not limited to, alkyl and allyl phthalates; napthalates; lactates (e.g., sodium, ammonium and potassium salts); sorbeth-30; urea; lactic acid; sodium pyrrolidone carboxylic acid (PCA); sodium hyraluronate or hyaluronic acid; soluble collagen; modified protein; monosodium L-glutamate; alpha & beta hydroxyl acids such as glycolic acid, lactic acid, citric acid, maleic acid and salicylic acid; glyceryl polymethacrylate; polymeric plasticizers such as polyquaterniums; proteins and amino acids such as glutamic acid, aspartic acid, and lysine; hydrogen starch hydrolysates; other low molecular weight esters (e.g., esters of C₂-C₁₀ alcohols and acids); and any other water soluble plasticizer known to one skilled in the art of the foods and plastics industries; and mixtures thereof.

Particularly preferred examples of plasticizers include glycerin, ethylene glycol, polyethylene glycol, propylene glycol, and mixtures thereof. Most preferred plasticizer is glycerin.

In addition to the above-described ingredients, e.g., the water-soluble polymer, the surfactant(s) and the plasticizer, the flexible, dissolvable, porous article of the present invention may comprise one or more additional ingredients, depending on its intended application. Such one or more additional ingredients may be selected from the group consisting of fabric care actives, dishwashing actives, hard surface cleaning actives, beauty and/or skin care actives, personal cleansing actives, hair care actives, oral care actives, feminine care actives, baby care actives, and any combinations thereof.

Suitable fabric care actives include but are not limited to: organic solvents (linear or branched lower C₁-C₈ alcohols, diols, glycerols or glycols; lower amine solvents such as C₁-C₄ alkanolamines, and mixtures thereof more specifically 1,2-propanediol, ethanol, glycerol, monoethanolamine and triethanolamine), carriers, hydrotropes, builders, chelants, dispersants, enzymes and enzyme stabilizers, catalytic materials, bleaches (including photobleaches) and bleach activators, perfumes (including encapsulated perfumes or perfume microcapsules), colorants (such as pigments and dyes, including hueing dyes), brighteners, dye transfer inhibiting agents, clay soil removal/anti-redeposition agents, structurants, rheology modifiers, suds suppressors, processing aids, fabric softeners, anti-microbial agents, and the like.

Suitable hair care actives include but are not limited to: moisture control materials of class II for frizz reduction (salicylic acids and derivatives, organic alcohols, and esters), cationic surfactants (especially the water-insoluble type having a solubility in water at 25° C. of preferably below 0.5 g/100 g of water, more preferably below 0.3 g/100 g of water), high melting point fatty compounds (e.g., fatty alcohols, fatty acids, and mixtures thereof with a melting point of 25° C. or higher, preferably 40° C. or higher, more preferably 45° C. or higher, still more preferably 50° C. or higher), silicone compounds, conditioning agents (such as hydrolyzed collagen with tradename Peptein 2000 available from Hormel, vitamin E with tradename Emix-d available from Eisai, panthenol available from Roche, panthenyl ethyl ether available from Roche, hydrolyzed keratin, proteins, plant extracts, and nutrients), preservatives (such as benzyl alcohol, methyl paraben, propyl paraben and imidazolidinyl urea), pH adjusting agents (such as citric acid, sodium citrate, succinic acid, phosphoric acid, sodium hydroxide, sodium carbonate), salts (such as potassium acetate and sodium chloride), coloring agents, perfumes or fragrances, sequestering agents (such as disodium ethylenediamine tetra-acetate), ultraviolet and infrared screening and absorbing agents (such as octyl salicylate), hair bleaching agents, hair perming agents, hair fixatives, anti-dandruff agents, anti-microbial agents, hair growth or restorer agents, co-solvents or other additional solvents, and the like.

Suitable beauty and/or skin care actives include those materials approved for use in cosmetics and that are described in reference books such as the CTFA Cosmetic Ingredient Handbook, Second Edition, The Cosmetic, Toiletries, and Fragrance Association, Inc. 1988, 1992. Further non-limiting examples of suitable beauty and/or skin care actives include preservatives, perfumes or fragrances, coloring agents or dyes, thickeners, moisturizers, emollients, pharmaceutical actives, vitamins or nutrients, sunscreens, deodorants, sensates, plant extracts, nutrients, astringents, cosmetic particles, absorbent particles, fibers, anti-inflammatory agents, skin lightening agents, skin tone agent (which functions to improve the overall skin tone, and may include vitamin B3 compounds, sugar amines, hexamidine compounds, salicylic acid, 1,3-dihydroxy-4-alkybenzene such as hexylresorcinol and retinoids), skin tanning agents, exfoliating agents, humectants, enzymes, antioxidants, free radical scavengers, anti-wrinkle actives, anti-acne agents, acids, bases, minerals, suspending agents, pH modifiers, pigment particles, anti-microbial agents, insect repellents, shaving lotion agents, co-solvents or other additional solvents, and the like.

Non-limiting examples of product type embodiments that can be formed by the flexible, dissolvable, porous article of the present invention include laundry detergent products, fabric softening products, hand cleansing products, hair shampoo or other hair treatment products, body cleansing products, shaving preparation products, dish cleaning products, personal care substrates containing pharmaceutical or other skin care actives, moisturizing products, sunscreen products, beauty or skin care products, deodorizing products, oral care products, feminine cleansing products, baby care products, fragrance-containing products, and so forth.

### IV. Processes for Making Flexible, Dissolvable, Porous Sheets

The flexible, dissolvable, porous article of the present invention may comprise one or more layers of flexible, porous, dissolvable solid sheets, which can be formed by a method comprising the steps of: (a) forming a pre-mixture containing raw materials (e.g., the water-soluble polymer, active ingredients such as surfactants, and optionally a plasticizer) dissolved or dispersed in water or a suitable solvent, which is characterized by a viscosity of from about 1,000 cps to about 25,000 cps measured at about 40° C. and 1 s⁻¹; (b) aerating the pre-mixture (e.g., by introducing a gas into the wet slurry) to form an aerated wet pre-mixture; (c) forming the aerated wet pre-mixture into a sheet having opposing first and second sides; and (d) drying the formed sheet for a drying time of from 1 minute to 60 minutes at a temperature from 70° C. to 200° C. along a heating direction that forms a temperature gradient decreasing from the first side to the second side of the formed sheet, wherein the heating direction is substantially offset from the gravitational direction for more than half of the drying time, i.e., the drying step is conducted under heating along a mostly “anti-gravity” heating direction. Such a mostly “anti-gravity” heating direction can be achieved by various means, which include but are not limited to bottom conduction-based heating/drying arrangement and rotary drum-based heating/drying arrangement.

The wet pre-mixture is generally prepared by mixing solids of interest, including the water-soluble polymer, surfactant(s) and/or other benefit agents, optional plasticizer, and other optional ingredients, with a sufficient amount of water or another solvent in a pre-mix tank. The wet pre-mixture can be formed using a mechanical mixer. Mechanical mixers useful herein, include, but aren't limited to pitched blade turbines or MAXBLEND mixer (Sumitomo Heavy Industries).

It is particularly important in the present invention to adjust viscosity of the wet pre-mixture so that it is within a predetermined range of from about 1,000 cps to about 25,000 cps when measured at 40° C. and 1 s⁻¹. Viscosity of the wet pre-mixture has a significant impact on the pore expansion and pore opening of the aerated pre-mixture during the subsequent drying step, and wet pre-mixtures with different viscosities may form flexible, porous, dissolvable solid sheets of very different foam structures. In one embodiment, viscosity of the wet pre-mixture ranges from about 3,000 cps to about 24,000 cps, preferably from about 5,000 cps to about 23,000 cps, more preferably from about 10,000 cps to about 20,000 cps, as measured at 40° C. and 1 sec⁻¹. The pre-mixture v iscosity values are measured using a Malvern Kinexus Lab+ rheometer with cone and plate geometry (CP1/50 SR3468 SS), a gap width of 0.054 mm, a temperature of 40° C. and a shear rate of 1.0 reciprocal seconds for a period of 360 seconds.

In a preferred but not necessary embodiment, the solids of interest are present in the wet pre-mixture at a level of from about 15% to about 70%, preferably from about 20% to about 50%, more preferably from about 25% to about 45% by total weight of the wet pre-mixture. The percent solid content is the summation of the weight percentages by weight of the total processing mixture of all solid components, semi-solid components and liquid components excluding water and any obviously volatile materials such as low boiling alcohols.

Among the solids of interest in the wet pre-mixture of the present invention, there may be present from about 1% to about 75% surfactant(s), from about 0.1% to about 25% water-soluble polymer, and optionally from about 0.1% to about 25% plasticizer, by total weight of the solids. Other actives or benefit agents can also be added into the pre-mixture.

Optionally, the wet pre-mixture is pre-heated immediately prior to and/or during the aeration process at above ambient temperature but below any temperatures that would cause degradation of the components therein. In one embodiment, the wet pre-mixture is kept at an elevated temperature ranging from about 40° C. to about 100° C., preferably from about 50° C. to about 95° C., more preferably from about 60° C. to about 90° C., most preferably from about 75° C. to about 85° C. In one embodiment, the optional continuous heating is utilized before the aeration step. Further, additional heat can be applied during the aeration process to try and maintain the wet pre-mixture at such an elevated temperature. This can be accomplished via conductive heating from one or more surfaces, injection of steam or other processing means. It is believed that the act of pre-heating the wet pre-mixture before and/or during the aeration step may provide a means for lowering the viscosity of pre-mixtures comprising higher percent solids content for improved introduction of bubbles into the mixture and formation of the desired solid sheet. Achieving higher percent solids content is desirable since it may reduce the overall energy requirements for drying. The increase of percent solids may therefore conversely lead to a decrease in water level content and an increase in viscosity. As mentioned hereinabove, wet pre-mixtures with viscosities that are too high are undesirable for the practice of the present invention. Pre-heating may effectively counteract such viscosity increase and thus allow for the manufacture of a fast dissolving sheet even when using high solid content pre-mixtures.

Aeration of the wet pre-mixture is conducted in order to introduce a sufficient amount of air bubbles into the wet pre-mixture for subsequent formation of the OCF structures therein upon drying. Once sufficiently aerated, the wet pre-mixture is characterized by a density that is significantly lower than that of the non-aerated wet pre-mixture (which may contain a few inadvertently trapped air bubbles) or an insufficiently aerated wet pre-mixture (which may contain some bubbles but at a much lower volume percentage and of significantly larger bubble sizes). Preferably, the aerated wet pre-mixture has a density ranging from about 0.05 g/ml to about 0.5 g/ml, preferably from about 0.08 g/ml to about 0.4 g/ml, more preferably from about 0.1 g/ml to about 0.35 g/ml, still more preferably from about 0.15 g/ml to about 0.3 g/ml, most preferably from about 0.2 g/ml to about 0.25 g/ml.

Aeration can be accomplished by either physical or chemical means in the present invention. In one embodiment, it can be accomplished by introducing a gas into the wet pre-mixture through mechanical agitation, for example, by using any suitable mechanical processing means, including but not limited to: a rotor stator mixer, a planetary mixer, a pressurized mixer, a non-pressurized mixer, a batch mixer, a continuous mixer, a semi-continuous mixer, a high shear mixer, a low shear mixer, a submerged sparger, or any combinations thereof In another embodiment, it may be achieved via chemical means, for example, by using chemical foaming agents to provide in-situ gas formation via chemical reaction of one or more ingredients, including formation of carbon dioxide (CO₂ gas) by an effervescent system.

In a particularly preferred embodiment, the aeration of the wet pre-mixture is achieved by using a continuous pressurized aerator or mixer that is conventionally utilized in the foods industry in the production of marshmallows. Continuous pressurized mixers may work to homogenize or aerate the wet pre-mixture to produce highly uniform and stable foam structures with uniform bubble sizes. The unique design of the high shear rotor/stator mixing head may lead to uniform bubble sizes in the layers of the open celled foam. Suitable continuous pressurized aerators or mixers include the Morton whisk (Morton Machine Co., Motherwell, Scotland), the Oakes continuous automatic mixer (E.T. Oakes Corporation, Hauppauge, N.Y.), the Fedco Continuous Mixer (The Peerless Group, Sidney, Ohio), the Mondo (Haas-Mondomix B.V., Netherlands), the Aeros (Aeros Industrial Equipment Co., Ltd., Guangdong Province, China), and the Preswhip (Hosokawa Micron Group, Osaka, Japan). For example, an Aeros A20 continuous aerator can be operated at a feed pump speed setting of about 300-800 (preferably at about 500-700) with a mixing head speed setting of about 300-800 (preferably at about 400-600) and an air flow rate of about 50-150 (preferably 60-130, more preferably 80-120) respectively. For another example, an Oakes continuous automatic mixer can be operated at a mixing head speed setting of about 10-30 rpm (preferably about 15-25 rpm, more preferably about 20 rpm) with an air flow rate of about 10-30 Litres per hour (preferably about 15-25 L/hour, more preferably about 19-20 L/hour).

In another specific embodiment, aeration of the wet pre-mixture can be achieved by using the spinning bar that is a part of the rotary drum dryer, more specifically a component of the feeding trough where the wet pre-mixture is stored before it is coated onto the heated outer surface of the drum dryer and dried. The spinning bar is typically used for stirring the wet pre-mixture to preventing phase separation or sedimentation in the feeding trough during the waiting time before it is coated onto the heated rotary drum of the drum dryer. In the present invention, it is possible to operate such spinning bar at a rotating speed ranging from about 150 to about 500 rpm, preferably from about 200 to about 400 rpm, more preferably from about 250 to about 350 rpm, to mix the wet pre-mixture at the air interface and provide sufficient mechanical agitation needed for achieving the desired aeration of the wet pre-mixture.

As mentioned hereinabove, the wet pre-mixture can be maintained at an elevated temperature during the aeration process, so as to adjust viscosity of the wet pre-mixture for optimized aeration and controlled draining during drying. For example, when aeration is achieved by using the spinning bar of the rotary drum, the aerated wet pre-mixture in the feeding trough is typically maintained at about 60° C. during initial aeration by the spinning bar (while the rotary drum is stationary), and then heated to about 70° C. when the rotary drum is heated up and starts rotating.

Bubble size of the aerated wet pre-mixture assists in achieving uniform layers in the OCF structures of the resulting solid sheet. In one embodiment, the bubble size of the aerated wet pre-mixture is from about 5 to about 100 microns; and in another embodiment, the bubble size is from about 20 microns to about 80 microns. Uniformity of the bubble sizes causes the resulting solid sheets to have consistent densities.

After sufficient aeration, the aerated wet pre-mixture forms one or more sheets with opposing first and second sides. The sheet-forming step can be conducted in any suitable manners, e.g., by extrusion, casting, molding, vacuum-forming, pressing, printing, coating, and the like. More specifically, the aerated wet pre-mixture can be formed into a sheet by: (i) casting it into shallow cavities or trays or specially designed sheet moulds; (ii) extruding it onto a continuous belt or screen of a dryer; (iii) coating it onto the outer surface of a rotary drum dryer. Preferably, the supporting surface upon which the sheet is formed is formed by or coated with materials that are anti-corrosion, non-interacting and/or non-sticking, such as metal (e.g., steel, chromium, and the like), TEFLON®, polycarbonate, NEOPRENE®, HDPE, LDPE, rubber, glass and the like.

Preferably, the formed sheet of aerated wet pre-mixture has a thickness ranging from a thickness ranging from 0.5 mm to 4 mm, preferably from 0.6 mm to 3.5 mm, more preferably from 0.7 mm to 3 mm, still more preferably from 0.8 mm to 2 mm, most preferably from 0.9 mm to 1.5 mm.

Drying of the so-formed sheet of aerated wet pre-mixture is conducted in an anti-gravity manner, either by using a conduction-based heating/drying arrangement or a rotary drum-based heating/drying arrangement.

Drum drying is particularly preferred as a continuous drying process suitable for drying large volumes. The heated rotatable cylinder used in drum drying is heated internally, e.g., by steam or electricity, and it is rotated by a motorized drive installed on a base bracket at a predetermined rotational speed. The heated rotatable cylinder or drum preferably has an outer diameter ranging from about 0.5 meters to about 10 meters, preferably from about 1 meter to about 5 meters, more preferably from about 1.5 meters to about 2 meters. It may have a controlled surface temperature of from about 80° C. to about 170° C., preferably from about 90° C. to about 150° C., more preferably from about 100° C. to about 140° C. Further, such heated rotatable cylinder is rotating at a speed of from about 0.005 rpm to about 0.25 rpm, preferably from about 0.05 rpm to about 0.2 rpm, more preferably from about 0.1 rpm to about 0.18 rpm.

The heated rotatable cylinder is preferably coated with a non-stick coating on its outer surface. The non-stick coating may be overlying on the outer surface of the heated rotatable drum, or it can be fixed to a medium of the outer surface of the heated rotatable drum. The medium includes, but is not limited to, heat-resisting non-woven fabrics, heat-resisting carbon fiber, heat-resisting metal or non-metallic mesh and the like. The non-stick coating can effectively preserve structural integrity of the sheet-like article from damage during the sheet-forming process.

There is also provided a feeding mechanism on the base bracket for adding the aerated wet pre-mixture of raw materials as described hereinabove onto the heated rotatable drum, thereby forming a thin layer of the viscous pre-mixture onto the outer surface of the heated rotatable drum. Such thin layer of the pre-mixture is therefore dried by the heated rotatable drum via contact-heating/drying. The feeding mechanism includes a feeding trough installed on the base bracket, while the feeding trough has installed thereupon at least one (preferably two) feeding hopper(s), an imaging device for dynamic observation of the feeding, and an adjustment device for adjusting the position and inclination angle of the feeding hopper. By using the adjustment device to adjust the distance between the feeding hopper and the outer surface of the heated rotatable drum, the need for different thicknesses of the formed sheet-like article can be met. The adjustment device can also be used to adjust the feeding hopper to different inclination angles so as to meet the material requirements of speed and quality. The feeding trough may also include a spinning bar for stirring the wet pre-mixture therein to avoid phase separation and sedimentation before the wet pre-mixture is coated onto the outer surface of the heated rotatable cylinder. Such spinning bar, as mentioned hereinbefore, can also be used to aerate the wet pre-mixture as needed.

There may also be a heating shield installed on the base bracket, to prevent rapid heat lost. The heating shield can also effectively save energy needed by the heated rotatable drum, thereby achieving reduced energy consumption and provide cost savings. The heating shield is a modular assembly structure, or integrated structure, and can be freely detached from the base bracket. A suction device is also installed on the heating shield for sucking the hot steam, to avoid any water condensate falling on the sheet-like article that is being formed.

There may also be an optional static scraping mechanism installed on the base bracket, for scraping or scooping up the sheet-like article already formed by the heated rotatable drum. The static scraping mechanism can be installed on the base bracket, or on one side thereof, for transporting the already formed sheet-like article downstream for further processing. The static scraping mechanism can automatically or manually move close and go away from the heated rotatable drum.

The making process of the flexible, porous, dissolvable solid sheet of the present invention is as follows. Firstly, the heated rotatable drum with the non-stick coating on the base bracket is driven by the motorized drive. Next, the adjustment device adjusts the feeding mechanism so that the distance between the feeding hopper and the outer surface of the heated rotatable drum reaches a preset value. Meanwhile, the feeding hopper adds the aerated wet pre-mixture containing all or some raw materials for making the flexible, porous, dissolvable solid sheet onto an outer surface of the heated rotatable drum, to form a thin layer of the aerated wet pre-mixture thereon with the desired thickness as described hereinabove in the preceding section. Optionally, the suction device of the heating shield sucks the hot steam generated by the heated rotatable drum. Next, the static scraping mechanism scrapes/scoops up a dried/solidified sheet, which is formed by the thin layer of aerated wet pre-mixture after it is dried by the heated rotatable drum at a relatively low temperature (e.g., 130° C.). The dried/solidified sheet can also be manually or automatically peeled off, without such static scraping mechanism and then rolled up by a roller bar.

The total drying time in the present invention depends on the formulations and solid contents in the wet pre-mixture, the drying temperature, the thermal energy influx, and the thickness of the sheet material to be dried. Preferably, the drying time is from about 1 minute to about 60 minutes, preferably from about 2 minutes to about 30 minutes, more preferably from about 2 to about 15 minutes, still more preferably from about 2 to about 10 minutes, most preferably from about 2 to about 5 minutes.

During such drying time, the heating direction is so arranged that it is substantially opposite to the gravitational direction for more than half of the drying time, preferably for more than 55% or 60% of the drying time (e.g., as in the rotary drum-based heating/drying arrangement described hereinabove), more preferably for more than 75% or even 100% of the drying time (e.g., as in the bottom conduction-based heating/drying arrangement described hereinabove). Further, the sheet of aerated wet pre-mixture can be dried under a first heating direction for a first duration and then under a second, opposite heating direction under a second duration, while the first heating direction is substantially opposite to the gravitational direction, and while the first duration is anywhere from 51% to 99% (e.g., from 55%, 60%, 65%, 70% to 80%, 85%, 90% or 95%) of the total drying time. Such change in heating direction can be readily achieved by various other arrangements not illustrated herein, e.g., by an elongated heated belt of a serpentine shape that can rotate along a longitudinal central axis.

Once the flexible, dissolvable, porous solid sheet is formed by the above-described process, an optional coating composition can be applied to one or more of said solid sheets before multiple sheets are stacked together to form the three-dimensional article of the present invention. The coating composition may comprise a surfactant that is different from that contained in the sheets (a second surfactant) together with a rheology modifier and optionally a solvent. The coating composition may help to load additional ingredients, including perfumes and surfactants, into the flexible, dissolvable, porous article of the present invention for additional consumer benefits and improved performance. In a preferred embodiment of the present invention, the second surfactant may comprise a non-ionic surfactant, more preferably a C₆-C₂₀ linear or branched alkylalkoxylated alcohols (AA) having a weight average degree of alkoxylation ranging from 5 to 15, preferably C₁₂-C₁₄ linear ethoxylated alcohols having a weight average degree of alkoxylation ranging from 7 to 9. The coating composition preferably have a viscosity of from about 1 cps to about 25,000 cps, preferably from about 2 cps to about 10,000 cps, more preferably from about 3 cps to about 5,000 cps, most preferably from about 1,000 cps to about 5,000 cps, as measured at about 20° C. and 1 s⁻¹. The viscosity values are measured using a Malvern Kinexus Lab+ rheometer with cone and plate geometry (CP1/50 SR3468 SS), a gap width of 0.054 mm, a temperature of 20° C. and a shear rate of 1.0 reciprocal seconds for a period of 360 seconds.

Once the coating composition is applied, a plurality of the above-mentioned flexible, dissolvable, porous solid sheets can be stacked together to form a three-dimensional article according to the present invention, which can be of any desirable three-dimensional shapes, including but not limited to: spherical, cubic, rectangular, oblong, cylindrical, rod, sheet, flower-shaped, fan-shaped, star-shaped, disc-shaped, and the like. The sheets can be combined and/or treated by any means known in the art, examples of which include but are not limited to, chemical means, mechanical means, and combinations thereof. Such combination and/or treatment steps are hereby collectively referred to as a “conversion” process, i.e., which functions to convert two or more flexible, dissolvable, porous sheets of the present invention into a unitary article.

The flexible, dissolvable, porous article of the present invention may comprise individual sheets of different colors, which are visual from an external surface (e.g., one or more side surfaces) of such article. Such visible sheets of different colors are aesthetically pleasing to the consumers. Further, the different colors of individual sheets may provide visual cues indicative of different benefit agents contained in the individual sheets. For example, the multilayer dissolvable solid article may comprise a first sheet that has a first color and contains a first benefit agent and a second sheet that has a second color and contains a second benefit, while the first color provides a visual cue indicative of the first benefit agent, and while the second color provides a visual cue indicative of the second benefit agent.

### Test Methods

### Test 1: Measurement of Compression Force and Rebound Time

A 25 mm diameter hollow circular hole punch is used to cut a sample disc of about 25 mm in diameter from a flexible, dissolvable, porous article of about 8 mm in thickness (as measured by using a Vernier callipers). Said article can comprise a stack of multiple flexible, dissolvable, porous sheets (e.g., those formed by the drum-drying manufacturing process as described hereinabove) to achieve the desired thickness. The sample disc is stored in an oven with temperature and humidity control capability, for a minimum duration of 4 hours at 25° C. with an equilibrium humidity of 40%.

The compressibility measurements are carried out using a Haake Mars II rheometer, with a PP60 mm plate-plate measuring geometry (model number 222-1271) and an MPC60 measuring plate (model number 222-1550) installed into the rheometer control unit. The base plate temperature of said rheometer is set and controlled at 25° C. throughout the duration of the tests. The rheometer is firstly calibrated before starting the experiments by use of the software to ensure that the zero measurement distance and the zero normal force are both accurately set.

The compression test is then carried out as follows:
1) The 8 mm-thick sample disc is removed from the oven and immediately placed at the center of the MPC60 measuring plate. A thin layer of parafilm is placed on top of the stack to prevent the disc from sticking to the measuring geometry.
2) The measuring geometry is lowered to 4 mm (i.e., the rheometer measurement position) at a speed of 2.5 mm/min as set by the rheometer software. The rheometer measurement position is set at approximately 50% of the original thickness of the sample disc, thereby achieving a Volumetric Compression of about 50% in the sample disc.
3) Once the measuring geometry reaches 4 mm, it is kept stationary for 5 minutes and the pressure force applied thereto by the rheometer is recorded at every second.
4) Once 5 minutes have passed, the measuring geometry is raised, and the sample disc is manually removed.
5) The thickness of the removed sample disc is measured using a Vernier callipers, approximately starting at 5 seconds after the measuring geometry is raised and then every following 30 seconds.

The following parameters are then calculated as follows:

$$50 \% Compression Force ( \frac{N}{{m}^{2}} ) = \frac{\begin{matrix}Force measured at 1 second after the \\ rheometer measurement position is reached\end{matrix}}{\begin{matrix}Cross \text{-} sectional area of the sample disc \\ in contact with the measuring geometry plate\end{matrix}}$$

It is noticed that the actual compression force applied by the rheometer to the sample disc declines over time within the 5-minute measurement period, and the Average Compression Force is calculated as follows:

$$Average Compression Force ( \frac{N}{{m}^{2}} ) = \frac{Average force measured over 5 minutes}{\begin{matrix}Cross \text{-} sectional area of the sample disc \\ in contact with the measuring geometry plate\end{matrix}}$$

### Test 2: Percent Open Cell Content of the Article

The Percent Open Cell Content is measured via gas pycnometry. Gas pycnometry is a common analytical technique that uses a gas displacement method to measure volume accurately. Inert gases, such as helium or nitrogen, are used as the displacement medium. A sample of the flexible, dissolvable, porous article of the present invention is sealed in the instrument compartment of known volume, the appropriate inert gas is admitted, and then expanded into another precision internal volume. The pressure before and after expansion is measured and used to compute the sample article volume.

ASTM Standard Test Method D2856 provides a procedure for determining the percentage of open cells using an older model of an air comparison pycnometer. This device is no longer manufactured. However, one can determine the percentage of open cells conveniently and with precision by performing a test which uses Micromeritics' AccuPyc Pycnometer. The ASTM procedure D2856 describes 5 methods (A, B, C, D, and E) for determining the percent of open cells of foam materials. For these experiments, the samples can be analyzed using an Accupyc 1340 using nitrogen gas with the ASTM foampyc software. Method C of the ASTM procedure is to be used to calculate to percent open cells. This method simply compares the geometric volume as determined using calipers and standard volume calculations to the open cell volume as measured by the Accupyc, according to the following equation:

Percent Open Cell Content (%)=Open cell volume of sample/Geometric volume of sample*100%

It is recommended that these measurements be conducted by Micromeretics Analytical Services, Inc. (One Micromeritics Dr, Suite 200, Norcross, Ga. 30093). More information on this technique is available on the Micromeretics Analytical Services web sites (www.particletesting.com or www.micromeritics.com), or published in “Analytical Methods in Fine particle Technology” by Clyde Orr and Paul Webb.

### Test 3: Micro-Computed Tomographic (μCT) Method for Determining Overall Average Pore Size and Average Cell Wall Thickness of the Open Cell Foams (OCF)

Porosity is the ratio between void-space to the total space occupied by the OCF. Porosity can be calculated from μCT scans by segmenting the void space via thresholding and determining the ratio of void voxels to total voxels. Similarly, solid volume fraction (SVF) is the ratio between solid-space to the total space, and SVF can be calculated as the ratio of occupied voxels to total voxels. Both Porosity and SVF are average scalar-values that do not provide structural information, such as, pore size distribution in the height-direction of the OCF, or the average cell wall thickness of OCF struts.

To characterize the 3D structure of the OCFs, samples are imaged using a μCT X-ray scanning instrument capable of acquiring a dataset at high isotropic spatial resolution. One example of suitable instrumentation is the SCANCO system model 50 μCT scanner (Scanco Medical AG, Brüttisellen, Switzerland) operated with the following settings: energy level of 45 kVp at 133 μA; 3000 projections; 15 mm field of view; 750 ms integration time; an averaging of 5; and a voxel size of 3 μm per pixel. After scanning and subsequent data reconstruction is complete, the scanner system creates a 16 bit data set, referred to as an ISQ file, where grey levels reflect changes in x-ray attenuation, which in turn relates to material density. The ISQ file is then converted to 8 bit using a scaling factor.

Scanned OCF samples are normally prepared by punching a core of approximately 14 mm in diameter. The OCF punch is laid flat on a low-attenuating foam and then mounted in a 15 mm diameter plastic cylindrical tube for scanning. Scans of the samples are acquired such that the entire volume of all the mounted cut sample is included in the dataset. From this larger dataset, a smaller sub-volume of the sample dataset is extracted from the total cross section of the scanned OCF, creating a 3D slab of data, where pores can be qualitatively assessed without edge/boundary effects.

To characterize pore-size distribution in the height-direction, and the strut-size, Local Thickness Map algorithm, or LTM, is implemented on the subvolume dataset. The LTM Method starts with a Euclidean Distance Mapping (EDM) which assigns grey level values equal to the distance each void voxel is from its nearest boundary. Based on the EDM data, the 3D void space representing pores (or the 3D solid space representing struts) is tessellated with spheres sized to match the EDM values. Voxels enclosed by the spheres are assigned the radius value of the largest sphere. In other words, each void voxel (or solid voxel for struts) is assigned the radial value of the largest sphere that that both fits within the void space boundary (or solid space boundary for struts) and includes the assigned voxel.

The 3D labelled sphere distribution output from the LTM data scan can be treated as a stack of two-dimensional images in the height-direction (or Z-direction) and used to estimate the change in sphere diameter from slice to slice as a function of OCF depth. The strut thickness is treated as a 3D dataset and an average value can be assessed for the whole or parts of the subvolume. The calculations and measurements were done using AVIZO Lite (9.2.0) from Thermo Fisher Scientific and MATLAB (R2017a) from Mathworks.

### Test 4: Thickness of the Flexible, Dissolvable, Porous Sheets

Thickness of the flexible, porous, dissolvable sheet is obtained by using a micrometer or thickness gage, such as the Mitutoyo Corporation Digital Disk Stand Micrometer Model Number IDS-1012E (Mitutoyo Corporation, 965 Corporate Blvd, Aurora, Ill., USA 60504). The micrometer has a 1-inch diameter platen weighing about 32 grams, which measures thickness at an application pressure of about 0.09 psi (6.32 gm/cm²).

The thickness of the flexible, porous, dissolvable sheet is measured by raising the platen, placing a section of the sheet article on the stand beneath the platen, carefully lowering the platen to contact the sheet article, releasing the platen, and measuring the thickness of the sheet in millimeters on the digital readout. The sheet should be fully extended to all edges of the platen to make sure thickness is measured at the lowest possible surface pressure, except for the case of more rigid substrates which are not flat.

### Test 5: Final Moisture Content of the Article

Final moisture content of the article of the present invention is obtained by using a Mettler Toledo HX204 Moisture Analyzer (S/N B706673091). A minimum of 1 g of the dried sheet article is placed on the measuring tray. The standard program is then executed, with additional program settings of 10 minutes analysis time and a temperature of 110° C.

### Test 6: Basis Weight of the Article

Basis Weight of the flexible, porous, dissolvable article of the present invention is calculated as the weight of the article per area thereof (grams/m²). The area is calculated as the projected area onto a flat surface perpendicular to the outer edges of the article. The articles of the present invention are cut into sample squares of 10 cm×10 cm, so the area is known. Each of such sample squares is then weighed, and the resulting weight is then divided by the known area of 100 cm² to determine the corresponding basis weight.

For an article of an irregular shape, if it is a flat object, the area is thus computed based on the area enclosed within the outer perimeter of such object. For a spherical object, the area is thus computed based on the average diameter as 3.14×(diameter/2)². For a cylindrical object, the area is thus computed based on the average diameter and average length as diameter x length. For an irregularly shaped three-dimensional object, the area is computed based on the side with the largest outer dimensions projected onto a flat surface oriented perpendicularly to this side. This can be accomplished by carefully tracing the outer dimensions of the object onto a piece of graph paper with a pencil and then computing the area by approximate counting of the squares and multiplying by the known area of the squares or by taking a picture of the traced area (shaded-in for contrast) including a scale and using image analysis techniques.

### Test 7: Density of the Article

Density of the flexible, porous, dissolvable article of the present invention is determined by the equation: Calculated Density=Basis Weight of porous solid/(Porous Solid Thickness×1,000). The Basis Weight and Thickness of the article are determined in accordance with the methodologies described hereinabove.

### Test 8: Specific Surface Area of the Article

The Specific Surface Area of the flexible, porous, dissolvable article is measured via a gas adsorption technique. Surface Area is a measure of the exposed surface of a solid sample on the molecular scale. The BET (Brunauer, Emmet, and Teller) theory is the most popular model used to determine the surface area and is based upon gas adsorption isotherms. Gas Adsorption uses physical adsorption and capillary condensation to measure a gas adsorption isotherm. The technique is summarized by the following steps; a sample is placed in a sample tube and is heated under vacuum or flowing gas to remove contamination on the surface of the sample. The sample weight is obtained by subtracting the empty sample tube weight from the combined weight of the degassed sample and the sample tube. The sample tube is then placed on the analysis port and the analysis is started. The first step in the analysis process is to evacuate the sample tube, followed by a measurement of the free space volume in the sample tube using helium gas at liquid nitrogen temperatures. The sample is then evacuated a second time to remove the helium gas. The instrument then begins collecting the adsorption isotherm by dosing krypton gas at user specified intervals until the requested pressure measurements are achieved. Samples may then analyzed using an ASAP 2420 with krypton gas adsorption. It is recommended that these measurements be conducted by Micromeretics Analytical Services, Inc. (One Micromeritics Dr, Suite 200, Norcross, Ga. 30093). More information on this technique is available on the Micromeretics Analytical Services web sites (www.particletesting.com or www.micromeritics.com), or published in a book, “Analytical Methods in Fine Particle Technology”, by Clyde Orr and Paul Webb.

### EXAMPLES

### Example 1

### Comparative Tests Showing Different 50% Compression Force and 90% Rebound Time Demonstrated by Different Flexible, Dissolvable, Porous Articles

Three (3) inventive examples of flexible, dissolvable, porous articles (A)-(C) with high compressibility and reboundability according to the present invention are provided, together with two comparative examples of articles (1)-(2).

The inventive examples (A)-(C) and the comparative examples (1)-(2) are made by stacking up multiple layers of flexible, dissolvable, porous solid sheets made a drum-drying process as described hereinabove, with the following wet (before drying) and dry (after drying) formulations:

TABLE 1

| | Sheet for (A) | | Sheet for (B) | | Sheet for (C) | |
|---|---|---|---|---|---|---|
| Ingredients | Wet (%) | Dry (%) | Wet (%) | Dry (%) | Wet (%) | Dry (%) |
| Polyvinyl alcohol (Degree of | 6.44 | 19.91 | 10.07 | 24.5 | — | — |
| polymerization 1700) | | | | | | |
| Polyvinyl alcohol (Degree of | — | — | — | — | — | — |
| polymerization 500) | | | | | | |
| Polyvinyl alcohol (Celpol-523) | — | — | — | — | 6.54 | 20.62 |
| Glycerin | 2.91 | 9.01 | 14.39 | 35 | 2.5 | 7.88 |
| Linear Alkylbenzene Sulfonate | — | — | — | — | — | — |
| C12-C14 Ethoxylated alcohol | — | — | — | — | — | — |
| Sodium Laureth-1 Sullfate | 15.2 | 47.03 | — | — | 12 | 37.84 |
| Sodium Laureth-3 Sullfate | 3.9 | 12.05 | — | — | 0.8 | 2.53 |
| Sodium Lauroamphoacetate | — | — | — | — | 3.08 | 9.71 |
| Rewoquat Ci-Deedmac (Evonik) | — | — | 10.28 | 25 | — | — |
| Potato Starch | — | — | 0.62 | 1.5 | — | — |
| Ethoxylated Polyethyleneimine | 0.65 | 2 | — | — | — | — |
| Palm kernel fatty acid soap powder | 0.65 | 2 | — | — | — | — |
| Sodium Aluminosilicate (crystalline)/ | 0.32 | 0.99 | — | — | — | — |
| Zeolite | | | | | | |
| Silicone Dioxide (Precipitated Silica | — | — | 0.82 | 2 | — | — |
| Particles) | | | | | | |
| Silicone Emulsion | — | — | — | — | 1 | 3.15 |
| Perfume Oil | — | — | — | — | 1.66 | 5.23 |
| Perfume Microcapsule | — | — | 0.82 | 2 | — | — |
| Citric acid | — | — | — | — | 0.55 | 1.73 |
| Sodium Benzoate | — | — | — | — | 0.11 | 0.35 |
| Guar Hydroxypropyltrimonium Chloride | — | — | — | — | 0.3 | 0.95 |
| Moisture | 69.94 | 7 | 63 | 10 | 71.46 | 10 |
| Total | 100 | 100 | 100 | 100 | 100 | 100 |
| Solids Percentage | 30.1 | 93 | 37 | 90 | 28.5 | 90 |

| | |
|---|---|
| Sheet for (1) | Sheet for (2) |

| Ingredients | Wet (%) | Dry (%) | Wet (%) | Dry (%) |
|---|---|---|---|---|
| Polyvinyl alcohol (Degree of | 7.34 | 17.93 | 3.08 | 6.78 |
| polymerization 1700) | | | | |
| Polyvinyl alcohol (Degree of | 2.45 | 5.98 | 6.15 | 13.56 |
| polymerization 500) | | | | |
| Glycerin | 1.73 | 4.23 | 3.08 | 6.78 |
| Linear Alkylbenzene Sulfonate | 16.24 | 39.65 | — | — |
| C12-C14 Ethoxylated alcohol | 6.5 | 15.88 | — | — |
| Sodium Laureth-3 Sullfate | 1.89 | 4.62 | — | — |
| Sodium Lauryl Sulfate | — | — | 16.56 | 36.5 |
| Sodium C14-16 alpha olefin sulfonate | — | — | 13.33 | 29.38 |
| Ethoxylated Polyethyleneimine | 0.64 | 1.56 | — | — |
| Palm kernel fatty acid soap powder | 0.88 | 2.14 | — | — |
| Sodium Aluminosilicate (crystalline)/ | 0.41 | 1.01 | — | — |
| Zeolite | | | | |
| Moisture | 61.91 | 7.00 | 57.82 | 7 |
| Total | 100 | 100 | 100 | 100 |
| Solids Percentage | 38.1 | 93 | 42.2 | 93 |

The invention examples (A)-(C) and comparative examples (1)-(2) are subjected to the 50% Compression Force and Rebound Time measurements as described in Test 1 hereinabove, and the test results are as follows:

TABLE 2

| Samples | (A) | (B) | (C) | (1) | (2) |
|---|---|---|---|---|---|
| Density (g/L) | 100.0 | 273.7 | 96.5 | 160.0 | 216.0 |
| Thickness of single | 1.33 | 1.14 | 1.14 | 1.00 | 0.90 |
| sheet (mm) | | | | | |
| Number of sheets | 6 | 7 | 7 | 8 | 9 |
| in the stack | | | | | |
| Basis weight (g/m²) | 133.3 | 240 | 84 | 160.0 | 240 |
| 50% Compression | 5,701 | 11,640 | 1,603 | 23,806 | 97,138* |
| Force (N/m²) | | | | | |
| Average Compression | 3,691 | 8,840 | 1,189 | 12,413 | 75,605 |
| Force (N/m²) | | | | | |
| 90% Rebound Time** | <30 s | <30 s | <30 s | 5 min | >10 min |

*Could not be compressed sufficiently to reach a Volumetric Compression of 50% due to the maximum force limitations of the rheometer. Only capable of reaching a maximum Volumetric Compression of about 43%.
**The time taken for the compressed sample to rebound to 90% of its original thickness/volume.

The above examples show significant differences between flexible, dissolvable, porous articles in their respective 50% Compression Force and 90% Rebound Time. Therefore, it is desirable to select the more compressible and reboundable articles (e.g., the inventive examples) according to the present invention for handling/manipulation through compression and decompression, e.g., by applying a moderate force under normal manufacturing/shipping/storage conditions.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of handling or manipulating a flexible, dissolvable, porous article comprising the steps of:
d) providing a flexible, dissolvable, porous article comprising a water-soluble polymer and a surfactant; wherein said flexible, dissolvable, porous article is characterized by: (1) a 50% Compression Force of less than 20,000 N/m²; and (2) a 90% Rebound Time of less than 5 minutes, when measured at 25° C. with an equilibrium humidity of 40%;
e) applying a force ranging from 500 N/m² to 100,000 N/m² to said flexible, dissolvable, porous article at a temperature ranging from 20° C. to 40° C. and an equilibrium humidity ranging from 20% to 95% so as to achieve a Volumetric Compression of 50% or more; and
f) removing the force from said compressed flexible, dissolvable, porous article so as to achieve a Volumetric Rebound of about 80% or more in less than 10 minutes.

2. The method of claim 1, wherein the force applied in Step (b) is selected from the group consisting of pressure force, vacuum force, suction force, torque, and combinations thereof.

3. The method of claim 1, wherein the flexible, dissolvable, porous article is characterized by a Percent Open Cell Content of from about 80% to about 99%, and an Overall Average Pore Size of from about 200 μm to about 600 μm.

4. The method according to claim 1, wherein said flexible, dissolvable, porous article is characterized by a maximum dimension D and a minimum dimension z; and wherein the ratio of D/z ranges from about 2 to about 7.

5. The method according to claim 1, wherein said flexible, dissolvable, porous article comprises multiple flexible, dissolvable, porous sheets, each of which has a thickness ranging from about 0.8 mm to about 2 mm; wherein said article comprises from about 6 to about 30, of said flexible, dissolvable, porous sheets.

6. The method according to claim 1, wherein said flexible, dissolvable, porous article comprises from about 10% to about 30%, of said water-soluble polymer by total weight of said article; wherein said water-soluble polymer has a weight average molecular weight of from about 80,000 to 150,000 Daltons; and comprises a polyvinyl alcohol characterized by a degree of hydrolysis ranging from about 70% to about 90%.

7. The method according to claim 1, wherein said flexible, dissolvable, porous article comprises from about 40% to about 80%, of said surfactant by total weight of said article.

8. The method according to claim 1, wherein in Step (b), the force applied is a vacuum force; wherein said flexible, dissolvable, porous article is placed inside a fluid-impermeable package before application of said vacuum force; wherein said fluid-impermeable package is sealed after the Volumetric Compression of 50% or more is achieved.

9. The method of claim 8, wherein in Step (c), removal of said vacuum force from said compressed flexible, dissolvable, porous article requires breaking the seal of said fluid-impermeable package.

10. A method of packaging a flexible, dissolvable, porous article comprising the steps of:
a) providing a flexible, dissolvable, porous article comprising a water-soluble polymer and a surfactant; wherein said flexible, dissolvable, porous article is characterized by a 50% Compression Force of less than 100,000 N/m² when measured at 25° C. with an equilibrium humidity of 40%;
b) placing one or more of said flexible, dissolvable, porous articles into a fluid-impermeable package;
c) applying a vacuum force to said flexible, dissolvable, porous articles to achieve a Volumetric Compression of 20% or more; and
d) sealing said fluid-impermeable package with the compressed flexible, dissolvable, porous articles inside.

11. The method of claim 10, wherein the flexible, dissolvable, porous article is characterized by a Percent Open Cell Content of from about 80% to about 99%, and an Overall Average Pore Size of from about 200 μm to about 600 μm.

12. The method of claim 10, wherein said flexible, dissolvable, porous article is characterized by a maximum dimension D and a minimum dimension z; and wherein the ratio of D/z ranges from about 2 to about 7.

13. The method according to claim 10, wherein said flexible, dissolvable, porous article comprises multiple flexible, dissolvable, porous sheets, each of which has a thickness ranging from about 0.8 mm to about 2 mm; wherein said article comprises from about 6 to about 30, of said flexible, dissolvable, porous sheets.

14. The method according to claim 10, wherein said flexible, dissolvable, porous article comprises from about 10% to about 30%, of said water-soluble polymer by total weight of said article; wherein said water-soluble polymer has a weight average molecular weight of from about 80,000 to 150,000 Daltons; and comprises a polyvinyl alcohol characterized by a degree of hydrolysis ranging from about 70% to about 90%.

15. The method according to claim 10, wherein said flexible, dissolvable, porous article comprises from about 40% to about 80%, of said surfactant by total weight of said article.

16. A compressed flexible, dissolvable, porous article comprising a water-soluble polymer and a surfactant, wherein said compressed article is characterized by a Volumetric Rebound of 20% or more in less than 10 minutes upon decompression.

17. The compressed flexible, dissolvable, porous article of claim 16, wherein said compressed article is placed inside a sealed fluid-impermeable package, and wherein decompression is achieved by opening of said sealed fluid-impermeable package.

18. The compressed flexible, dissolvable, porous article of claim 16, wherein the compressed article is characterized by a Percent Open Cell Content of from about 80% to about 99%, and an Overall Average Pore Size of from about 200 μm to about 600 μm.

19. The compressed flexible, dissolvable, porous article according to claim 16, wherein said article is characterized by a maximum dimension D and a minimum dimension z; and wherein the ratio of D/z ranges from about 2 to about 7.

20. The compressed flexible, dissolvable, porous article according to claim 16, wherein said compressed flexible, dissolvable, porous article comprises multiple flexible, dissolvable, porous sheets, each of which has a thickness ranging from about 0.8 mm to about 2 mm; wherein said article comprises from about 6 to about 30, of said flexible, dissolvable, porous sheets.
